(19) United States
(12) Patent Application Publication
(10) Pub. No.: US 2012/0319865 A1
(43) Pub. Date: Dec. 20, 2012

(54) ASSIGNING TOWER MULTICAST ADDRESS TO ELECTRONIC UTILITY METERS

(75) Inventors: Bradley Richard Ree, Cumming, GA (US); Robert Warren Hepler, Wylie, TX (US); Ryan Marc LaFrance, Marietta, GA (US)

(73) Assignee: GENERAL ELECTRIC COMPANY, Schenectady, NY (US)

(21) Appl. No.: 13/159,591

(22) Filed: Jun. 14, 2011

(51) Int. Cl. G08C 15/06

(52) U.S. Cl. 340/870.03

(57) ABSTRACT

A system including a computer device configured to associate a tower multicast address with a first radio frequency (RF) tower; and assign the tower multicast address to each of a plurality of electronic utility meters communicating through the first RF tower.

### BACKGROUND OF THE INVENTION

This invention relates generally to electronic utility meters and more particularly to a system for assigning a tower multicast address to electronic utility meters.

Referring to FIG. 1, a block diagram of a known star network for communication with electronic utility meters is shown. A star network 102 may include a head end server 104 sending a communication to at least one dedicated tower 108a-b. Head end server 104 may be included with advanced metering infrastructure 106. Each dedicated tower 108a-b, in turn, communicates with each of a plurality of electronic utility meters 110a-f associated with each dedicated tower 108a-b. Each electronic utility meter 110a-f may communicate with dedicated tower 108a-b and dedicated tower 108a-b with head end server 104. Dedicated tower 108a-b may be known by terms such as “take out point” or “concentrator.” Head end server 104 may communicate with dedicated tower 108a-b by Internet using Internet Protocol addresses. Dedicated tower 108a-b may communicate with electronic utility meters 110a-f using a 900 Mhz radio transmission, 400 Mhz radio transmission, or other known dedicated radio frequency transmissions.

Dedicated tower 108a-b typically is a proprietary tower—owned by a utility company and nearly exclusively used for communicating with electronic utility meters 110a-f. Dedicated tower 108a-b may facilitate communication with specific groups of electronic utility meters 110a-f. For example, dedicated tower 108a communicates exclusively with electronic utility meters 110a-c. Using this example, if the utility company needs to inform a neighborhood using electronic utility meters 110a-c of a planned power outage, dedicated tower 108a could be used to communicate that message to each of electronic utility meters 110a-c. However, dedicated towers 108a-b—due to their proprietary nature—may be an expensive option for achieving this type of communication.

### SUMMARY OF THE INVENTION

A first aspect of the invention includes a system, comprising: a computer device configured to: associate a tower multicast address with a first radio frequency (RF) tower; and assign the tower multicast address to each of a plurality of electronic utility meters communicating through the first RF tower.

A second aspect of the invention includes a system, comprising: a plurality of electronic utility meters, each electronic utility meter communicating through a first radio frequency (RF) tower; and a computer device configured to: associate a tower multicast address with the first RF tower; and assign the tower multicast address to each of a plurality of electronic utility meters communicating through the first RF tower.

A third aspect of the invention includes a system, comprising: a plurality of electronic utility meters, each electronic utility meter including a radio frequency (RF) modem for communicating and for sending a meter identification; a first radio frequency (RF) tower configured for sending a tower identification; and a computer device configured to: associate a tower multicast address with the first RF tower; and assign the tower multicast address to each of the plurality of electronic utility meters.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a block diagram of a known star network for communication with electronic utility meters.

FIG. 2 shows a block diagram of one embodiment of a system in accordance with the invention.

FIG. 3 shows a block diagram of one embodiment of a system in accordance with the invention.

FIG. 4 shows a flow diagram for use in describing a method according to an embodiment of the invention.

FIG. 5 shows a block diagram of one embodiment of a system in accordance with the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

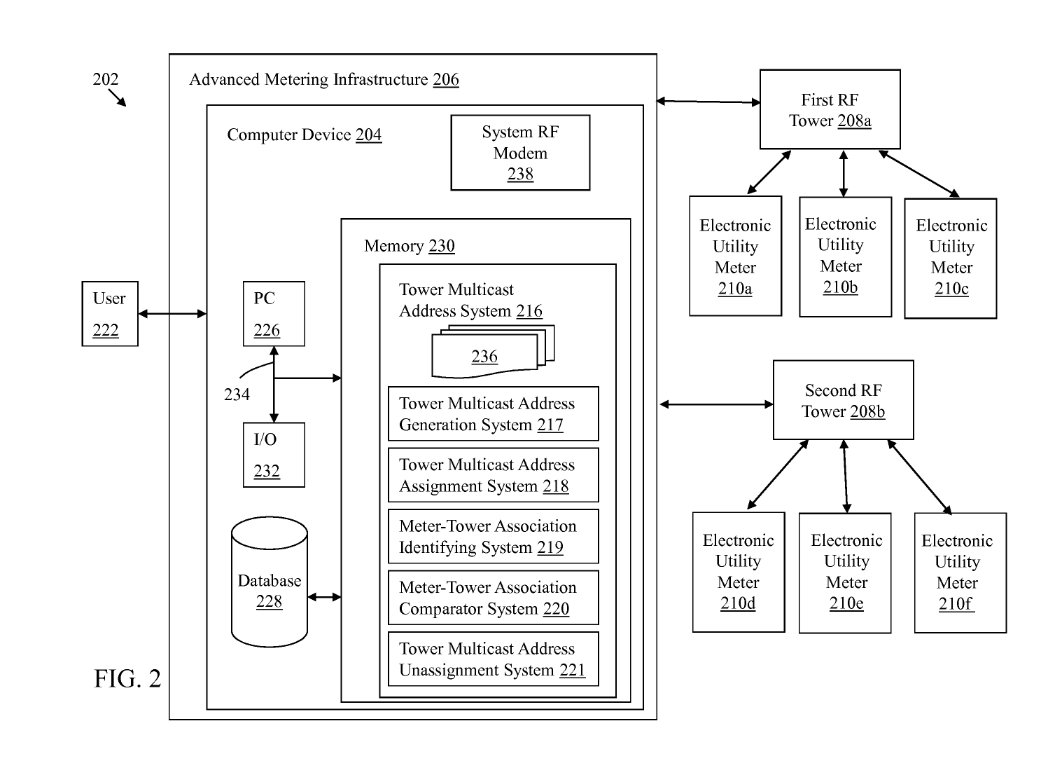

Referring to FIG. 2, a block diagram of one embodiment of meter communication system 202 in accordance with the invention is shown. Computer device 204 may include a tower multicast address system 216, which makes computer device 204 operable to receive a meter identification and a tower identification, identify a meter-tower association, generate a tower multicast address, associate tower multicast address with a plurality of radio frequency (RF) towers 208a-b, assign tower multicast address to a plurality of electronic utility meters 210a-f for multicast communication to plurality of electronic utility meters 210a-c through RF towers 208a-b, compare a current meter-tower association with a previous meter-tower association, identify a new meter-tower association, unassign tower multicast address from electronic utility meter with a new meter-tower association. As indicated in FIG. 2, a tower multicast address generation system 217, a tower multicast address assignment system 218, a meter-tower association identifying system 219, a meter-tower association comparator system 220, and a tower multicast address unassignment system 221 may be optional components (or, modules) in tower multicast address system 216. Alternatively, tower multicast address generation system 217, tower multicast address assignment system 218, meter-tower association identifying system 219, meter-tower association comparator system 220, and tower multicast address unassignment system 221 may be part of an external system which may perform the functions described herein.

Computer device 204 is shown in communication with user 222. User 222 may be a human, for example, a programmer or operator and/or a computerized system interacting with tower multicast address system 216. Communications between user 222 and computer device 204 can be implemented using any solution, such as a graphical interface, an application programming interface (API), and/or the like. Furthermore, communications can utilize any combination of public and/or private networks. Computer device 204 is shown including a processing component 226 (e.g., one or more processors), a database 228, a memory 230, an input/output (I/O) component 232 (e.g., one or more I/O interfaces and/or devices), and a communications pathway 234. In one embodiment, processing component 226 executes program code, such as tower multicast address system 216, which is at least partially embodied in memory 230. While executing program code, processing component 226 can process data, which can result in reading and/or writing the data to/from database 228, memory 230 and/or I/O component 232 for further processing. Communications pathway 234 provides a communications link between each of the components in computer device 204. I/O component 232 can comprise one or more human I/O devices or storage devices, which enable user 222 to interact with computer device 204 and/or one or more communications devices to enable user 222 to communicate with computer device 204 using any type of communications link. To this extent, tower multicast address system 216 can manage a set of interfaces (e.g., graphical user interface(s), application program interface, and/or the like) that enable human and/or system interaction with tower multicast address system 216.

In any event, computer device 204 can comprise one or more general purpose computing articles of manufacture (e.g., computing devices) capable of executing program code installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, tower multicast address system 216 can be embodied as any combination of system software and/or application software. In any event, the technical effect of tower multicast address system 216 is to receive meter identification and tower identification, identify meter-tower association, generate tower multicast address, associate tower multicast address with plurality of RF towers 208a-b, assign tower multicast address to plurality of electronic utility meters 210a-f for multicast communication to plurality of electronic utility meters 210a-c through RF towers 208a-b, compare current meter-tower association with previous meter-tower association, identify new meter-tower association, unassign tower multicast address from electronic utility meter with new meter-tower association.

Further, tower multicast address system 216 can be implemented using a set of modules 236. In this case, a module 236 can enable computer device 204 to perform a set of tasks used by tower multicast address system 216, and can be separately developed and/or implemented apart from other portions of tower multicast address system 216. Tower multicast address system 216 may include modules 236 which comprise a specific use machine/hardware and/or software. Regardless, it is understood that two or more modules, and/or systems may share some/all of their respective hardware and/or software. Further, it is understood that some of the functionality discussed herein may not be implemented or additional functionality may be included as part of computer device 204.

When computer device 204 comprises multiple computing devices, each computing device may have only a portion of tower multicast address system 216 embodied thereon (e.g., one or more modules 236). However, it is understood that computer device 204 and tower multicast address system 216 are only representative of various possible equivalent computer systems that may perform a process described herein. To this extent, in other embodiments, the functionality provided by computer device 204 and tower multicast address system 216 can be at least partially implemented by one or more computing devices that include any combination of general and/or specific purpose hardware with or without program code. In each embodiment, the hardware and program code, if included, can be created using standard engineering and programming techniques, respectively.

Regardless, when computer device 204 includes multiple computing devices, the computing devices can communicate over any type of communications link. Further, while performing a process described herein, computer device 204 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

As discussed herein, tower multicast address system 216 enables computer device 204 to receive meter identification and tower identification, identify meter-tower association, generate tower multicast address, associate tower multicast address with plurality of RF towers 208a-b, assign tower multicast address to plurality of electronic utility meters 210a-f for multicast communication to plurality of electronic utility meters 210a-c through RF towers 208a-b, compare current meter-tower association with previous meter-tower association, identify new meter-tower association, unassign tower multicast address from electronic utility meter with new meter-tower association. Tower multicast address system 216 may include logic, which may include the following functions: tower multicast address generation system 217, tower multicast address assignment system 218, meter-tower association identifying system 219, meter-tower association comparator system 220, and tower multicast address unassignment system 221. In one embodiment, tower multicast address system 216 may include logic to perform the below-stated functions. Structurally, the logic may take any of a variety of forms such as a field programmable gate array (FPGA), a microprocessor, a digital signal processor, an application specific integrated circuit (ASIC) or any other specific use machine structure capable of carrying out the functions described herein. Logic may take any of a variety of forms, such as software and/or hardware. However, for illustrative purposes, tower multicast address system 216 and logic included therein will be described herein as a specific use machine. As will be understood from the description, while logic is illustrated as including each of the above-stated functions, not all of the functions are necessary according to the teachings of the invention as recited in the appended claims.

In one embodiment, the invention provides a computer program embodied in at least one computer-readable storage medium, which when executed, enables a computer system (e.g., computer device 204) to receive meter identification and tower identification, identify meter-tower association, generate tower multicast address, associate tower multicast address with plurality of RF towers 208a-b, assign tower multicast address to plurality of electronic utility meters 210a-f for multicast communication to plurality of electronic utility meters 210a-c through RF towers 208a-b, compare current meter-tower association with previous meter-tower association, identify new meter-tower association, unassign tower multicast address from electronic utility meter with new meter-tower association. To this extent, the computer-readable storage medium includes program code, such as tower multicast address system 216, which implements some or all of a process described herein. It is understood that the term “computer-readable storage medium” comprises one or more of any type of tangible medium of expression capable of embodying a copy of the program code (e.g., a physical embodiment). For example, the computer-readable storage medium can comprise: one or more portable storage articles of manufacture; one or more memory/storage components of a computing device; paper; and/or the like. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

In another embodiment, the invention provides a method of providing a copy of program code, such as tower multicast address system 216, which implements some or all of a process described herein. In this case, a computer system can generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program embodied in at least one computer-readable medium. In either case, the set of data signals can be transmitted/received using any type of communications link.

In still another embodiment, the invention provides a method of receiving meter identification and tower identification, identifying meter-tower association, generating tower multicast address, associating tower multicast address with plurality of RF towers 208a-b, assigning tower multicast address to plurality of electronic utility meters 210a-f for multicast communication to plurality of electronic utility meters 210a-c through RF towers 208a-b, comparing current meter-tower association with previous meter-tower association, identifying new meter-tower association, unassigning tower multicast address from electronic utility meter with new meter-tower association. In this case, a computer system, such as computer device 204, can be obtained (e.g., created, maintained, made available, etc.) and one or more modules for performing a process described herein can be obtained (e.g., created, purchased, used, modified, etc.) and deployed to the computer device 204. To this extent, the deployment can comprise one or more of: (1) installing program code on a computing device from a computer-readable medium; (2) adding one or more computing and/or I/O devices to the computer device 204; and (3) incorporating and/or modifying the computer device 204 to enable it to perform a process described herein.

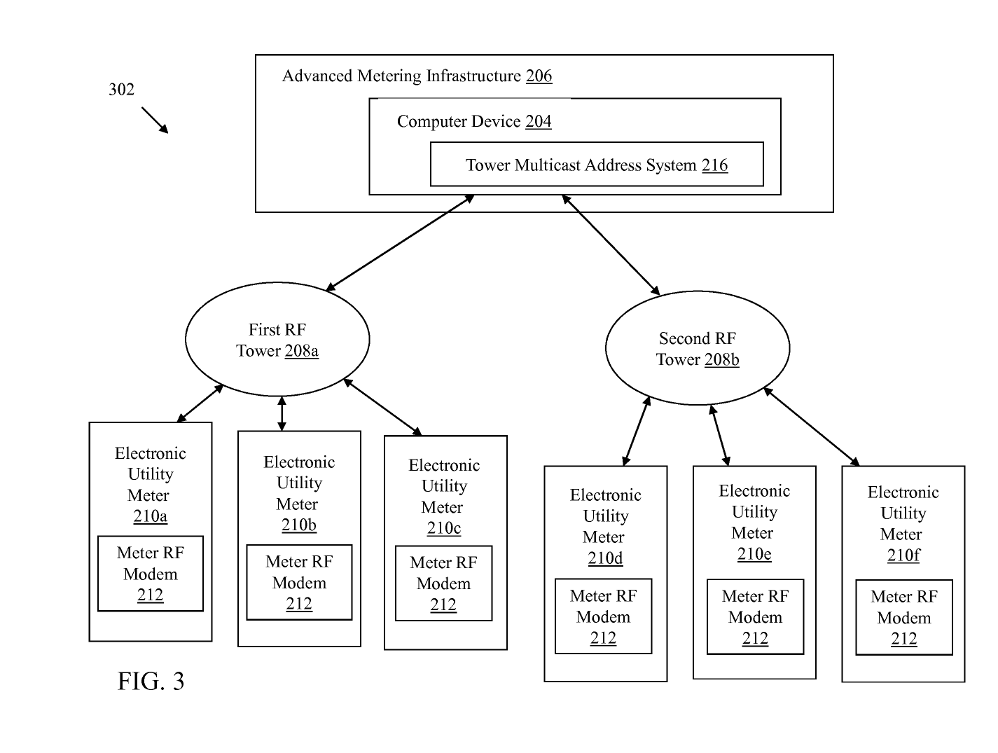

Referring to FIG. 3, one embodiment of a meter communication system 302 in accordance with the invention is illustrated. Meter communication system 302 may include a computer device 204 including a tower multicast address system 216. Meter communication system 302 may further include at least one radio frequency (RF) tower 208a-b and a plurality of electronic utility meters 210a-f. RF tower 208a-b may include communications operating in either a licensed band or unlicensed band, a cellular band, a 900 Mhz band, and a 400 Mhz band. RF tower 208a-b may be part of a private network or public network. RF tower 208a-b may be part of an advanced metering infrastructure network. RF tower 208a-b may include capability of communicating data, voice, video, and/or meter data. FIG. 3 shows two RF towers 208a-b (i.e., a first RF tower 208a and a second RF tower 208b) each tower communicating with a group of electronic utility meters (electronic utility meters 210a-c and electronic utility meters 210d-f, respectively). A person skilled in the art will readily recognize that the invention could include any number of RF towers 208a-b communicating with respective groups of electronic utility meters 210a-f. Each of the plurality of electronic utility meters 210a-f may include a radio frequency (RF) modem 212. Computer device 204 using a system radio frequency (RF) modem 238 (FIG. 2) may communicate through first RF tower 208a with plurality of electronic utility meters 210a-c and/or through second RF tower 208b with plurality of electronic utility meters 210d-f. RF modem 212 and system RF modem 238 may be compatible for communication with RF tower 208a-b.

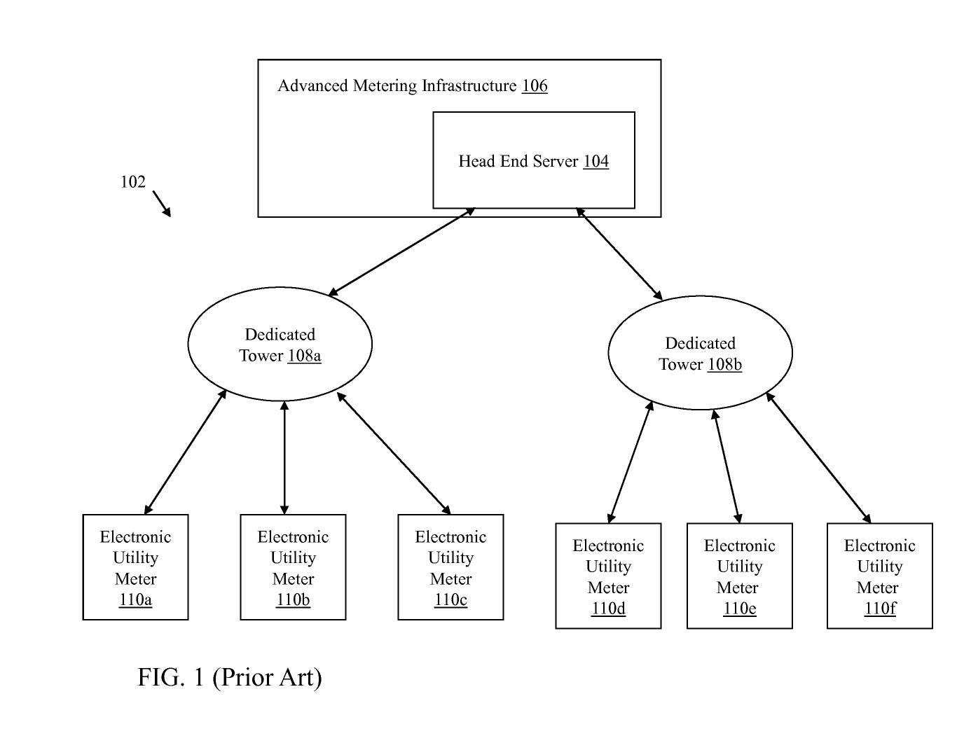

Computer device 204 may be part of head end server 104 (FIG. 1) or may be separate from head end server 104 (FIG. 1). Head end server 104 (FIG. 1) may be part of an advanced metering infrastructure (AMI) 206.

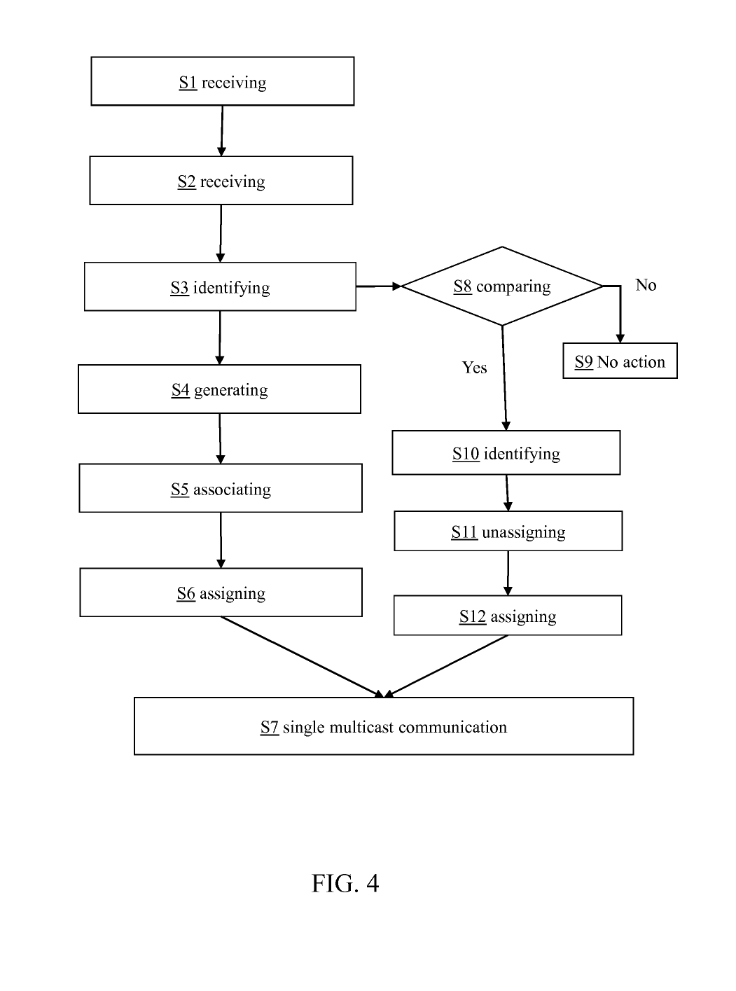

Continuing to refer to FIG. 3 and also FIG. 4, a flow diagram for use in describing a method according to an embodiment of the invention is illustrated. At S1, computer device 204 may receive a meter identification from each electronic utility meter 210a-f through its respective RF tower 208a-b. At S2, at approximately the same time as S1, computer device 204 may receive a tower identification from RF towers 208a-b. “Meter identification” and “tower identification” may include a unicast data communication protocol address, for example, an Internet Protocol (IP) address or a Media Access Control (MAC) address. At S3, meter-tower association identifying system 219 (FIG. 2) may identify a meter-tower association for each electronic utility meter 208a-f. For example, identifying meter-tower association may include pairing meter identification of each of electronic utility meters 210a-c to the tower identification of first RF tower 208a and/or may include pairing meter identification of each of electronic utility meters 210d-f to the tower identification of second RF tower 208b.

Communications from and to devices with data communication protocol addresses may include unicast, broadcast, and multicast format. Unicast format is a singular data communication protocol address communicating with another singular data communication protocol address. Broadcast format is the singular data communication protocol address communicating with all data communication protocol addresses within a given communication area. Multicast format is a singular data communication protocol address communicating with a specific group of data communication protocol addresses within a given communication area.

At S4, tower multicast address generation system 217 (FIG. 2) may generate a tower multicast address. “Tower multicast address” may be a data communication protocol address that allows for multicast communication using a single multicast communication through each RF tower 208a-b to the electronic utility meters 210a-f communicating through each RF tower 208a-b. For example, tower multicast address generation system 217 may generate a tower multicast address for first RF tower 208a that is unique to the first RF tower 208a and each electronic utility meter 210a-c communicating through first RF tower 208a. It should be readily understood that each tower multicast address generated is unique to each RF tower 208a-b and the electronic utility meters 210a-f respectively communicating through each RF tower 208a-b. Tower multicast address assignment system 218 may associate tower multicast address with each RF tower 208a-b and assign tower multicast address to each of the electronic utility meters 210a-f communicating through each RF tower 208a-b. For example, at S5 and S6, tower multicast address assignment system 218 associates tower multicast address with first RF tower 208a and assigns tower multicast address to each of the electronic utility meters 210a-c communicating through first RF tower 208a and associates tower multicast address with second RF tower 208b and assigns second multicast address to each of the electronic utility meters 210d-f communicating through second RF tower 208b.

At S7, computer device 204 may send the single multicast communication through first RF tower 208a to each electronic utility meter 210a-c using tower multicast address unique to first RF tower 208a and/or through second RF tower 208b to each electronic utility meter 210d-f using tower multicast address unique to second RF tower 208b. Multicast communication with electronic utility meters 210a-f may be less costly than a conventional unicast communication between computer device 204 and each electronic utility meter 210a-f individually. Further, multicast communication with electronic utility meters 210a-f may be more efficient than broadcast communication as the broadcast communication may be sent to more electronic utility meters 210a-f than actually need to receive the message. The use of RF towers 208a-b for communications with electronic utility meters 210a-f may allow for the use of equipment owned by a radio frequency (RF) company rather than the use of dedicated towers 108a-b (FIG. 1).

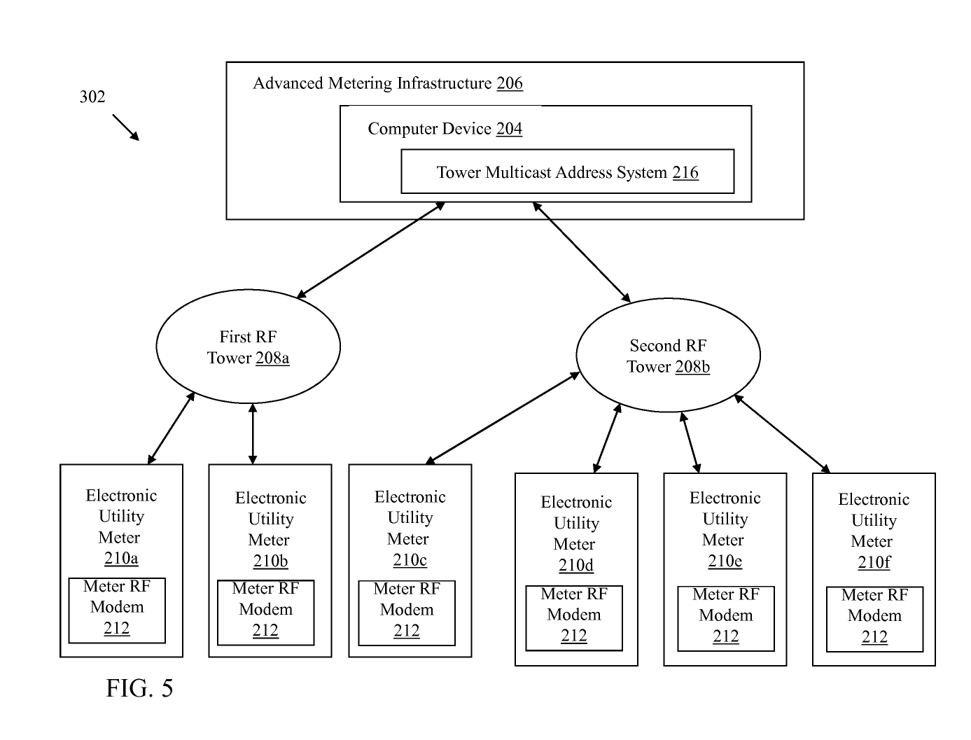

Referring to FIG. 5, a block diagram of one embodiment of system in accordance with the invention and, FIG. 4, a flow diagram for use in describing a method according to an embodiment of the invention are shown. Electronic utility meters 210a-f, in general, meter the utility usage of a residential or commercial customer and, as such, are generally connected with a structure. As a result, electronic utility meters 210a-f, in general, tend to stay in one geographic location. This static geographic location of electronic utility meters 210a-f facilitates the use of tower multicast address for multicast communications with electronic utility meters 210a-f. Most of the electronic utility meters 210a-f stay associated with the same RF tower 208a-b over time. For example, referring to FIG. 3 and FIG. 5, electronic utility meters 210a-b are associated with RF tower 208a and electronic utility meters 210a-b are associated with RF tower 208b. However, it is possible for some electronic utility meters 210a-f, for example electronic utility meter 208c, to be on a fringe of a communication range for two RF towers (e.g., first RF tower 208a and second RF tower 208b). Referring to FIGS. 3 and 5, electronic utility meter 210c changes its association from first RF tower 208a to second RF tower 208b.

Accordingly, tower multicast address system 216 may periodically receive tower identifications and meter identifications (see S1 and S2 FIG. 4). Periodically may include a set or a random time interval to be determined by user 222. At S8, meter-tower association comparator system 220 compares a current meter-tower association of each electronic utility meter 210a-f with a previous meter-tower association of each electronic utility meter 210a-f. At S9, no action may be required or taken in response to current meter-tower association and previous meter-tower association, for each electronic utility meter 210a-f, being the same. At S10, identifying a new meter-tower association in response to current meter-tower association and previous meter-tower association, for at least one electronic utility meter 210a-f, being different. At S11, in response to identifying new meter-tower association, tower multicast address unassignment system 221 may unassign tower multicast address from at least one electronic utility meter 210a-f with new meter-tower association. At S12, tower multicast address assignment system 218 may assign a tower multicast address of second RF tower to at least one electronic utility meter 210a-f with new meter-tower association. S11 and S12 may be completed substantially simultaneously. Subsequent to S11 and S12, single multicast communication may continue as described for S7 (FIG. 4).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system, comprising:
a computer device configured to:
associate a tower multicast address with a first radio frequency (RF) tower; and
assign the tower multicast address to each of a plurality of electronic utility meters communicating through the first RF tower.

2. The system of claim 1, wherein each of the plurality of electronic utility meters includes a radio frequency (RF) modem for communicating.

3. The system of claim 1, wherein the computer device is further configured to:
identify a meter-tower association for each of the plurality of electronic utility meters communicating through the first RF tower and wherein the assigning the tower multicast address to each of the plurality of electronic utility meters in response to the identifying of the meter-tower association.

4. The system of claim 3, wherein the meter-tower association includes a pairing of a meter identification received from each of the plurality of electronic utility meters communicating through the first RF tower and a tower identification received from the first RF tower.

5. The system of claim 1, wherein the computer device is further configured to communicate via the first RF tower with each of the plurality of electronic utility meters using a single multicast communication.

6. The system of claim 1, wherein the computer device is further configured to:
compare a current meter-tower association and a previous meter tower association;
identify a new meter-tower association for at least one electronic utility meter communicating through a second radio frequency (RF) tower in response to the comparing; and
assign a tower multicast address of the second RF tower to at least one electronic utility meter with the new meter-tower association.

7. The system of claim 6, wherein the tower multicast address is unassigned from the at least one electronic utility meter with the new meter-tower association in response to the identifying the new meter-tower association, and wherein at least one electronic utility meter with the new meter-tower association is assigned the tower multicast address of the second RF tower.

8. A system, comprising:
a plurality of electronic utility meters, each electronic utility meter communicating through a first radio frequency (RF) tower; and
a computer device configured to:
associate a tower multicast address with the first RF tower; and
assign the tower multicast address to each of a plurality of electronic utility meters communicating through the first RF tower.

9. The system of claim 8, wherein each of the plurality of electronic utility meters includes a radio frequency (RF) modem for communicating.

10. The system of claim 8, wherein the computer device is further configured to:
identify a meter-tower association for each of the plurality of electronic utility meters communicating through the first RF tower and wherein the assigning the tower multicast address to each of the plurality of electronic utility meters in response to the identifying of the meter-tower association.

11. The system of claim 10, wherein the meter-tower association includes a pairing of a meter identification received from each of the plurality of electronic utility meters communicating through the first RF tower and a tower identification received from the first RF tower.

12. The system of claim 8, wherein the computer device is further configured to communicate via the first RF tower with each of the plurality of electronic utility meters using a single multicast communication.

13. The system of claim 8, wherein the computer device is further configured to:
compare a current meter-tower association and a previous meter tower association;
identify a new meter-tower association for at least one electronic utility meter communicating through a second radio frequency (RF) tower in response to the comparing; and
assign a tower multicast address of the second RF tower to at least one electronic utility meter with the new meter-tower association.

14. The system of claim 13, wherein the tower multicast address is unassigned from the at least one electronic utility meter with the new meter-tower association in response to the identifying the new meter-tower association, and wherein at least one electronic utility meter with the new meter-tower association is assigned the tower multicast address of the second RF tower.

15. A system, comprising:
a plurality of electronic utility meters, each electronic utility meter including a radio frequency (RF) modem for communicating and for sending a meter identification;
a first radio frequency (RF) tower configured for sending a tower identification; and
a computer device configured to:
associate a tower multicast address with the first RF tower; and
assign the tower multicast address to each of the plurality of electronic utility meters.

16. The system of claim 15, wherein the computer device is further configured to:
identify a meter-tower association for each of the plurality of electronic utility meters communicating through the first RF tower and wherein the assigning the tower multicast address to each of the plurality of electronic utility meters in response to the identifying of the meter-tower association.

17. The system of claim 16, wherein the meter-tower association includes a pairing of a meter identification received from each of the plurality of electronic utility meters communicating through the first RF tower and a tower identification received from the first RF tower.

18. The system of claim 15, wherein the computer device is further configured to communicate via the first RF tower with each of the plurality of electronic utility meters using a single multicast communication.

19. The system of claim 15, wherein the computer device is further configured to:
compare a current meter-tower association and a previous meter tower association;
identify a new meter-tower association for at least one electronic utility meter communicating through a second radio frequency (RF) tower in response to the comparing; and
assign a tower multicast address of the second RF tower to at least one electronic utility meter with the new meter-tower association.

20. The system of claim 19, wherein the tower multicast address is unassigned from the at least one electronic utility meter with the new meter-tower association in response to the identifying the new meter-tower association, and wherein at least one electronic utility meter with the new meter-tower association is assigned the tower multicast address of the second RF tower.
